(19) United States
(12) Patent Application Publication
(10) Pub. No.: US 2015/0382217 A1
(43) Pub. Date: Dec. 31, 2015

(54) RADIO FREQUENCY DATA COLLECTION

(71) Applicant: HEWLETT-PACKARD DEVELOPMENT COMPANY, L.P., Houston, TX (US)

(72) Inventors: Andres Jose ODIO VIVI, San Jose (CR); Allan DELGADO CAMPOS, San Jose (CR); Francisco Jose ROJAS FONSECA, San Jose (CR)

(21) Appl. No.: 14/762,715

(22) PCT Filed: Mar. 14, 2013
(86) PCT No.: PCT/US2013/031803

§ 371 Date: Jul. 22, 2015

(51) Int. Cl. H04W 24/08; H04L 29/12; H04B 17/336; H04W 24/10; H04L 5/00

(52) U.S. Cl. CPC H04W 24/08; H04W 24/10; H04L 5/006; H04B 17/336; H04L 61/6022; H04W 84/12

(57) ABSTRACT

A network controller sends a request to a device for radio frequency (RF) environment data. The request is receive via a network interface of the device that includes at least one of a wired interface and a wireless interface. Responsive to the request, the device initiates a RF scan to collect the environment data. The collected RF environment data is transmitted to the network controller via the network interface.

### BACKGROUND

Wireless capable devices rely on network resources such as a wireless network access point to connect to the Internet (or network). Network administrators need to constantly monitor network environments to ensure optimum network performance and to detect any faults or security issues. To monitor and manage the network, a large amount of data is required to provide adequate information about the network environment.

### BRIEF DESCRIPTION OF THE DRAWINGS

The following detailed description references the drawings, wherein:

FIG. 1 is a block diagram of a device for scanning and collecting RF environment data, according to one example;

FIG. 2 is a block diagram of a network controller for receiving RF environment data, according to one example;

FIG. 3 is a block diagram of a system including a plurality of devices for providing RF environment data to a network controller via a network interface, according to one example;

FIG. 4 is a flowchart of a method of scanning and collecting RF environment data, according to one example; and

FIG. 5 is a flowchart of a method of scanning and collecting RF environment data, according to one example.

### DETAILED DESCRIPTION

Various aspects of the present disclosure are directed to collecting radio frequency (RF) data. More precisely, various aspects of the present disclosure are directed to crowdsourcing RF environment data using a plurality of wireless capable devices in a network.

RF environment data are typically provided by access points (APs) that are static in nature and hence provide limited data. Moreover, service availability to devices connected to APs may be impacted when such APs are scanning for RF environment data. Site surveys are costly and limit survey frequency, thereby leading to stale data.

Accordingly, examples disclosed herein provide a solution for crowdsourcing RF environment data using wireless capable devices in a network. In certain examples, a network controller receives RF environment data from any wireless-capable device in the network, either through a wired interface or a wireless interface. To illustrate, the network controller may send a request for RF environment data to a plurality of wireless capable devices connected thereto. For example, the request may be sent via a dynamic host configuration protocol (DHCP) option, a multicast message, or via an information element included in beacons transmitted by one or more APs. Thus, in some examples, the request is received via a wired interface (e.g., Ethernet port) of the device. In other examples, the request is received via a wireless interface (e.g., Wi-Fi interface) of the device. In both examples, in response to the request, a wireless radio of the device is enabled to initiate an RF scan to collect RF environment data.

In some examples, when the request is received, a handshake sequence is initiated between the device and the network controller (or any intermediary such as APs and switches) to negotiate data collection and transfer parameters. Accordingly, the RF environment data is collected and transmitted to the network controller based on the data collection and transfer parameters. In other examples, the device is preinstalled with software (or application) that instructs the device to scan the RF environment and report the RF environment data to the network controller.

The RF environment data may include, for example, wireless entities detectable by the device, operating channels of the wireless entities, signal strength data of the wireless entities, data related to packets transmitted over the network, identifying information related to the wireless entities, and a location of the device. The RF environment data may be usable by the network controller to manage and optimize the RF network infrastructure.

Accordingly, examples disclosed herein provide a solution where RF data collection is not limited to APs. Because there are more wireless capable devices in a network than APs, harnessing scanning capabilities of the devices would increase the amount of data available for network management. Further, by collecting RF data from mobile devices, the network controller is able to obtain a more complete picture of the RF environment. Moreover, the devices may gather RF data in such a way as to maximize efficiency and reduce disruption. For example, a device connected to the network via a wired interface would scan the RF environment via a wireless interface, and the scans may be limited to idle periods of communication over the wireless interface.

In one example, a device includes a network interface, where the network interface includes at least one of a wired interface and a wireless interface. The device also includes a processor configured to receive a request for RF environment data from a network controller through the network interface. The processor is configured to initiate a RF scan to collect the RF environment data, in response to the request. The processor is further configured to initiate transmission of the RF environment data to the network controller through the network interface.

In another example, a method includes receiving, by a device, a request for RF environment data from a network controller, where the request is received over a network interface of the device, and where the network interface includes at least one of a wired interface and a wireless interface. The method includes negotiating data collection and transfer parameters with the network controller, and initiating an RF scan to collect the RF environment data based on the data collection parameters. The method also includes transmitting the collected RF environment data to the network controller over the network interface based on the transfer parameters.

In another example, a non-transitory computer-readable medium includes instructions that, when executed by a processor of a network controller, cause the network controller to send a request for RF environment data to a plurality of client devices over a network interface, where the network interface includes at least one of a wired interface and a wireless interface. The instructions further cause the network controller to negotiate data collection and transfer parameters with the plurality of client devices, and receive the RF environment data from the plurality of client devices over the network interface based on the data collection and transfer parameters.

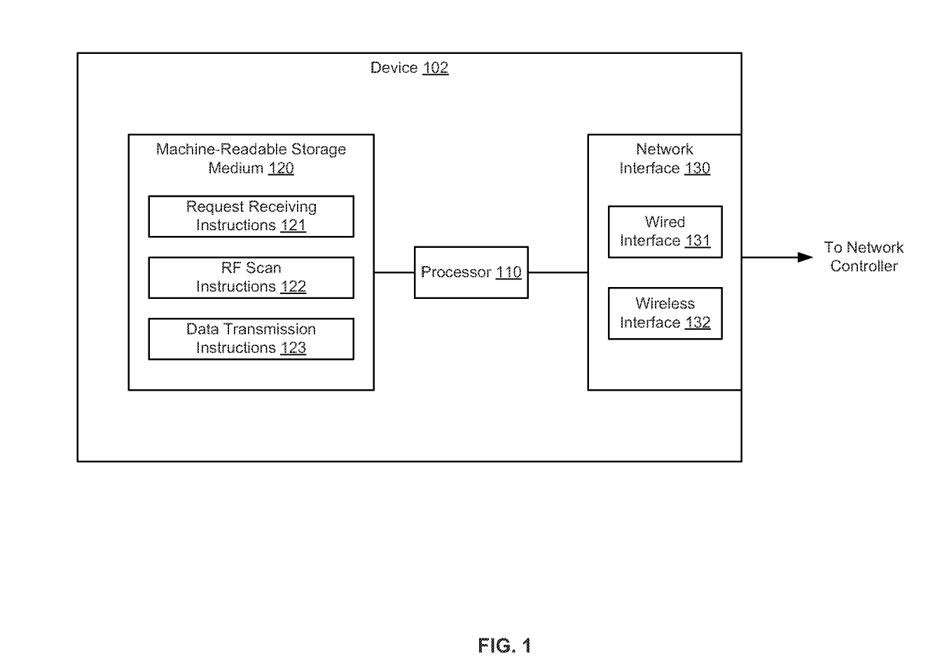

FIG. 1 depicts a block diagram of a device for scanning and collecting RF environment data, according to one example. Device 102 can be a tablet, a smartphone, a cellular device, a personal digital assistant (PDA), an all-in-one (AIO) computing device, a notebook, a convertible or hybrid notebook, a netbook, a laptop, a computing device, a printing device, and any other wireless capable device to scan a RF environment.

As shown in FIG. 1, device 102 includes a processor 110, a machine-readable storage medium 120, and a network interface 130. Network interface 130 may include at least one of a wired interface 131 and a wireless interface 132 to connect to the network. Wired interface 131 may be an Ethernet port, an external adaptor, or a wired or wireless (e.g., via a USB port, PCMCIA slot or Bluetooth connection) connection to another device connected to the network. Wireless interface 132 may be a wireless local area network (WLAN) (e.g., Wi-Fi, ad-hoc networks) and Bluetooth.

Processor 110 may be one or more central processing units (CPUs), microprocessors, and/or other hardware devices suitable for retrieval and execution of instructions stored in machine-readable storage medium 120. Processor 110 may fetch, decode, and execute instructions 121, 122, and 123 to enable scanning, collection, and transmission of RF environment data to a network controller as described below. As an alternative, or in addition to retrieving and executing instructions, processor 110 may include one or more electronic circuits comprising a number of electronic components for performing the functionality of one or more instructions 121, 122, and 123.

Machine-readable storage medium 120 may be an electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described below, machine-readable storage medium 120 may be encoded with executable instructions for enabling RF data collection.

Request receiving instructions 121 may receive a request for RF environment data from a network controller through network interface 130. For example, the network controller may advertise a crowdsourcing request through the wired interface 131 or the wireless interface 132 of the device. In some examples, if the request is sent through the wired interface, the request may be sent via DHCP option or a multicast message to the device 102. In other examples, if the request is sent through the wireless interface, the request may be sent via DHCP option or via an information element added to a beacon transmitted by one or more APs. In certain examples, the request includes instructions regarding how and when the data should be collected and sent, and what types of data to be collected.

RF scan instructions 122 may initiate an RF scan to collect the RF environment data, in response to the request. When the request is received, wireless interface 132 of the device 102 is enabled to initiate the RF scan. For example, the device 102 may be initially connected to the network via the wired interface 131 and the request from the network controller may be received at the device 102 via the wired interface 131. However, in response to the request, the wireless interface 132 may be enabled to initiate the RF scan to collect the RF environment data.

In certain examples, the RF scan is limited to idle periods of the wireless interface 132, to maximize efficiency of the device 102 and to reduce disruption of the device 102. In such examples, device 102 may collect and aggregate/store the RF environment data over a period of time, and time stamp the data prior to transmitting to the network controller. Accordingly, the device 102 may collect and transmit the RF data during idle periods to decrease the impact of scanning and transmitting data on the device 102.

In certain examples, the RF environment data includes a list of wireless entities (e.g., APs, ad-hoc cells, mobile devices, and Bluetooth devices) detectable by the device, operating channels of the wireless entities, signal strength data (e.g., SNR, SINR, RSSI, MCS, and transmit power) corresponding to the wireless entities, identifying information for the wireless entities (e.g., SSID, MAC address, and IP address), packet traffic in the network, and location information of the device 102 (e.g., via triangulation, magnetic field detection, and GPS).

Data transmission instructions 123 may initiate transmission of the RF environment data to the network controller through the network interface 130. For example, the RF environment data may be sent via the wired interface 131 or via the wireless interface 132.

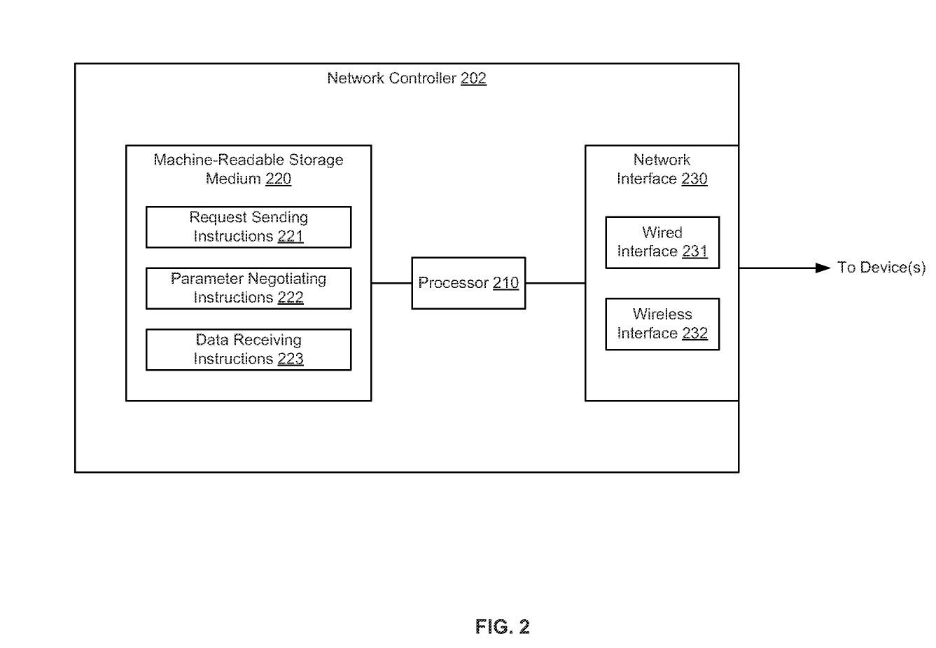

FIG. 2 depicts a block diagram of a network controller for receiving RF environment data from a device, according to one example. Network controller 202 can include a combination of hardware and software managing a network (e.g., a RF environment). For example, network controller 202 may manage a WLAN service provided to a plurality of client devices and wireless entities.

As shown in FIG. 2, network controller 202 includes a processor 210, a machine readable medium 220, and a network interface 230. Network interface 230 includes at least one of a wired interface 231 and a wireless interface 232 for connecting to a plurality of wired (e.g., printing devices, computing devices) and wireless entities (e.g., smartphones).

Processor 210 may be one or more central processing units (CPUs), microprocessors, and/or other hardware devices suitable for retrieval and execution of instructions stored in machine-readable storage medium 220. Processor 210 may fetch, decode, and execute instructions 221, 222, and 223. As an alternative, or in addition to retrieving and executing instructions, processor 210 may include one or more electronic circuits comprising a number of electronic components for performing the functionality of one or more instructions 221-223.

Machine-readable storage medium 220 may be an electronic, magnetic, optical, or other physical storage device that stores executable instructions. Thus, machine-readable storage medium 220 may be, for example, Random Access Memory (RAM), an Electrically-Erasable Programmable Read-Only Memory (EEPROM), a storage drive, an optical disc, and the like. As described below, machine-readable storage medium 220 may be encoded with executable instructions for receiving RF environment data.

Request sending instructions 221 may send a request for RF environment data to a plurality of client devices over the network interface 230. The request may be sent to the devices via the wired interface 231 or via the wireless interface 232. For example, the request may be sent via at least one of a DHCP option, a multicast message, and an information element included in AP beacons.

Parameter negotiating instructions 222 may negotiate data collection and data transfer parameters with the devices. The data collection parameters may specify types of data to be collected and when/how data is to be collected. For example, the data collection parameters may include at least one of frequency bands and channels to be scanned, wireless entities to be scanned, and data collection frequency. The data transfer parameters may specify how and when the collected data is to be transmitted to the network controller 202. For example, the data transfer parameters may include at least one of data transfer rate, data transmission frequency, data transfer method, coding and encryption schemes, and any other data transfer protocols to be utilized by the devices.

Data receiving instructions 223 may receive the RF environment data from the devices over the network interface 230 based at least in part on the data collection and transfer parameters. For example, the RF environment data may be received over the wired interface 231 or over the wireless interface 232.

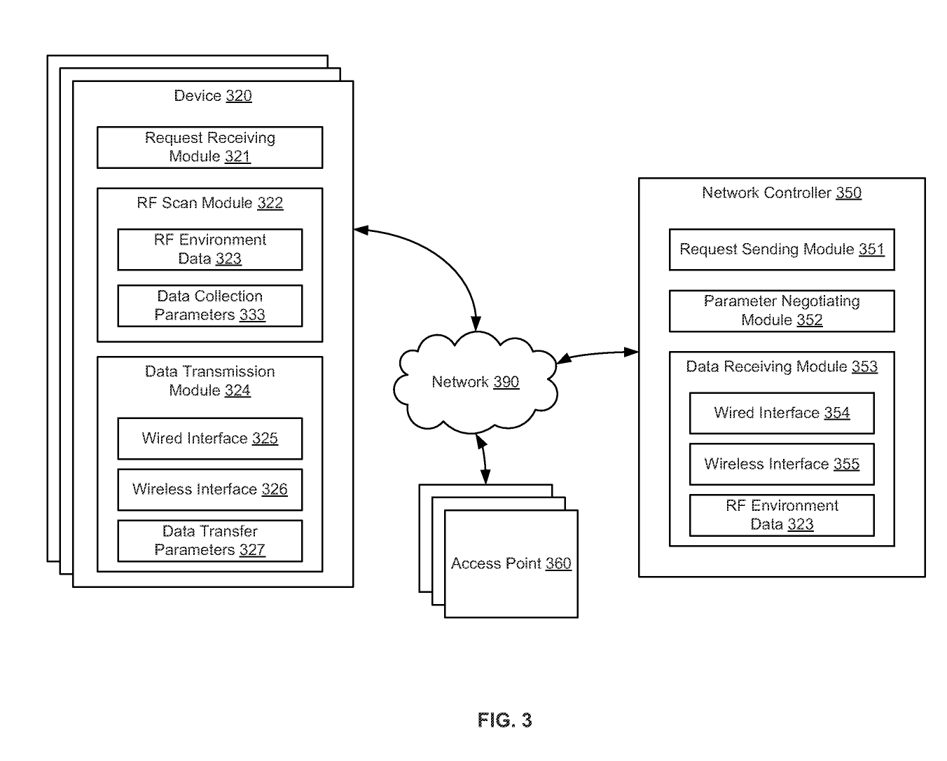

FIG. 3 depicts a block diagram of a system including a plurality of devices for providing RF environment data to a network controller via a network interface, according to one example. As illustrated in FIG. 3, network controller 350 may send a request for RF environment data to a plurality of devices 320 in the network 390. In certain examples, the request is sent via one or more access points associated with the devices 320.

As illustrated, devices 320 may each include a number of modules 321, 322, and 324, while network controller may include a number of modules 351, 352, and 353. Each of the modules may include a series of instructions encoded on a machine-readable storage medium and executable by a processor of the respective devices 320, 350. In addition, or as an alternative, each module may include one or more hardware devices including electronic circuitry for implementing the functionality described below.

As with device 102, the plurality of devices 320 may be a tablet, a smartphone, a cellular device, a personal digital assistant (PDA), an all-in-one (AIO) computing device, a notebook, a convertible or hybrid notebook, a netbook, a laptop, a computing device, a printing device, and any other wireless capable device to scan a RF environment.

Request receiving module 321 may receive a request for RF environment data from network controller 350. For example, the request may be received via at least one of the wired interface 325 and wireless interface 326 of the devices 320. The request may be sent via DHCP option, multicast message, or an information element included in a beacon transmitted by the APs 360.

RF scan module 322 may initiate an RF scan to collect RF environment data 323, responsive to the request. For example, the wireless interface 326 is enabled to scan the RF environment to collect data 323 based on data collection parameters 333. The scan may be performed during periods when the wireless interface 326 is idle.

Data transmission module 324 may initiate transmission of the RF environment data 323 to the network controller 350 over at least one of the wired interface 325 and the wireless interface 326 based on data transfer parameters 327 established with the network controller 350. In some examples, the RF environment data 323 is sent via at least one of the APs 360.

As with network controller 202 of FIG. 2, network controller 350 may manage the network 390 and provide network services to the plurality of devices 320 and the plurality of APs 360. As detailed below, network controller 350 may include a series of modules 351-353 for requesting and receiving RF environment data 323 from the plurality of devices 320. It should be noted that RF environment data 323 may also be requested and provided by the APs 360.

Request sending module 351 may send requests for RF environment data to devices 320 over at least one of the wired interface 354 and the wireless interface 355. In some examples, the request may be sent via a number of methods including DHCP option, multicast messaging, and an information element included in beacons transmitted by APs 360.

Parameter negotiating module 352 may negotiate data collection and transfer parameters with the devices 320. For example, the data collection parameters may include frequency bands and channels to be scanned, wireless entities to be scanned, and data collection frequency. The data transfer parameters may include data transfer rate, data transmission frequency, transfer methods, coding and encryption schemes, and other data transfer protocols, for example.

Data receiving module 353 may receive RF environment data 323 from the devices 320 over at least one of the wired interface 354 and the wireless interface 355, based on the data collection and transfer parameters. The RF environment data 323 is usable to manage the network 390 and to maintain the integrity and security of the network 390. For example, network controller 350 may use such RF environment data 323 to improve the throughput and security of the network 390 (e.g., by modifying the channel and transmit power parameters of APs 360, or by detecting rogue wireless entities), and detect performance issues. Moreover, a network administrator could examine a report log of the RF environment data and take actions to improve the network 390 (e.g., reconfigure or move APs 390, install or remove APs, locate and disconnect rogue devices, etc.).

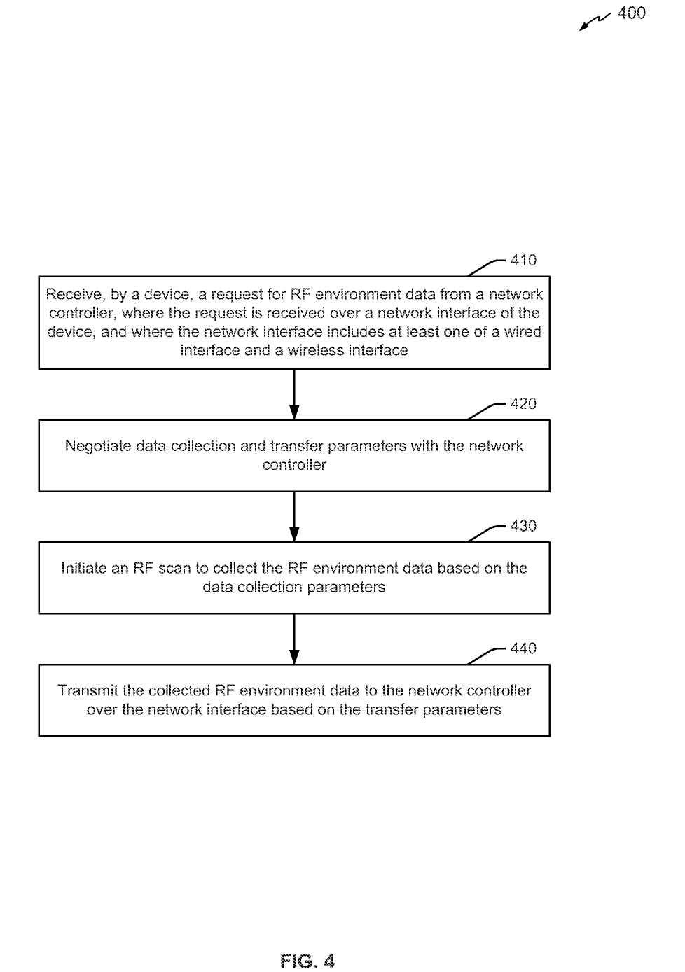

FIG. 4 is a flowchart of a method 400 of scanning and collecting RF environment data, according to one example. Although execution of method 400 is described below with reference to the components of device 102 and 320 of FIGS. 1 and 3, respectively, other suitable components for execution of method 400 will be apparent to those of skill in the art. Additionally, the components for executing method 400 may be spread among multiple devices. Moreover, method 400 may be implemented in the form of executable instructions stored on a machine-readable storage medium, such as non-transitory machine-readable storage medium 120 of FIG. 1, and/or in the form of electronic circuitry.

Method 400 includes receiving, by a device, a request for RF environment data from a network controller, where the request is received over a network interface of the device, and where the network interface includes at least one of a wired interface and a wireless interface, at 410. For example, the device may be connected to the network controller via a wireless interface or via a wired interface. Accordingly, the request may be received at the device via at least one of the wireless interface and the wired interface.

Method 400 includes negotiating data collection and transfer parameters with the network controller, at 420. For example, a handshake sequence may be initiated with the network controller or any intermediary devices (e.g., APs, switches) to determine parameters such as data exchange periodicity, data exchange method (e.g., pull or push), target wireless entities, and any other parameters that may be exchanged during the handshake or at any other time.

Method 400 includes initiating an RF scan to collect the RF environment data based on the data collection parameters, at 430. For example, the wireless interface of the device may be enabled to begin scanning the RF environment to collect the RF data.

Method 400 also includes transmitting the collected RF environment data to the network controller over the network interface based on the transfer parameters, at 440. For example, the collected RF environment data may be transmitted to the network controller over at least one of the wired interface and the wireless interface.

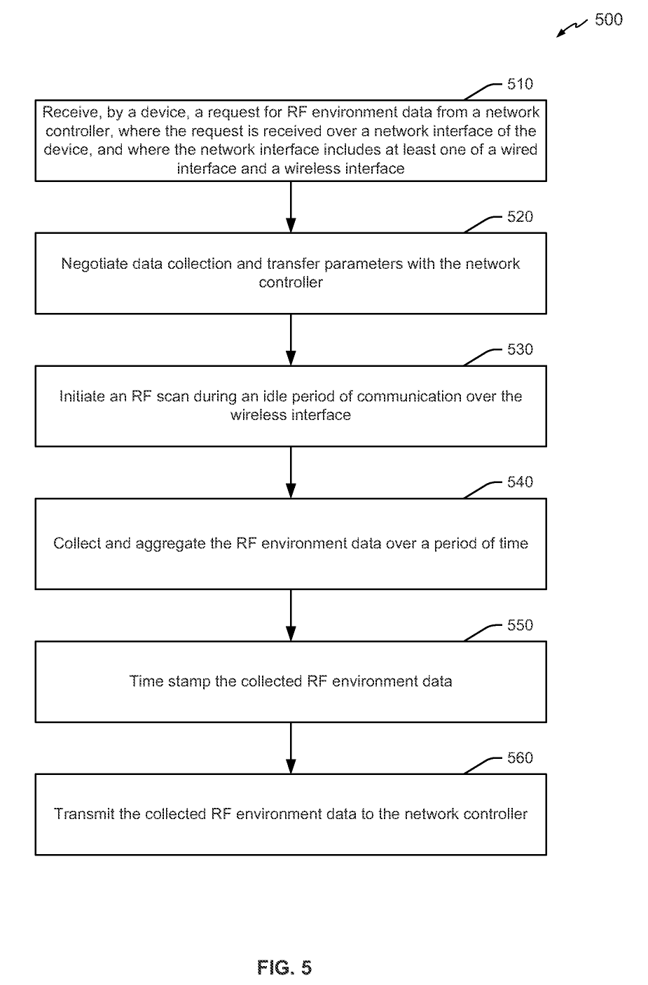

FIG. 5 is a flowchart of a method 500 of scanning and collecting RF environment data, according to one example. Although execution of method 500 is described below with reference to the components of device 102 and 320 of FIGS. 1 and 3, respectively, other suitable components for execution of method 500 will be apparent to those of skill in the art. Additionally, the components for executing method 500 may be spread among multiple devices. Moreover, method 500 may be implemented in the form of executable instructions stored on machine-readable storage medium, such as non-transitory machine-readable storage medium 120 of FIG. 1, and/or in the form of electronic circuitry.

Method 500 includes receiving, by a device, a request for RF environment data from a network controller, where the request is received over a network interface of the device, and where the network interface includes at least one of a wired interface and a wireless interface, at 510.

Method 500 includes negotiating data collection and transfer parameters with the network controller, at 520. For example, data collection and transfer parameters such as data exchange periodicity, data exchange methods (e.g., push v. pull), target entities, and other parameters may be established.

Method 500 includes initiating an RF scan during an idle period of communication over the wireless interface, at 530. For example, the RF environment scan is initiated when the device is not communicating over the wireless interface.

Method 500 includes collecting and aggregating the RF environment data over a period of time, at 540, and time stamping the collected RF environment data, at 550. For example, the RF environment data is collected over a period of time and time stamped to keep track of when the data was collected.

Method 500 also includes transmitting the collected RF environment data to the network controller, at 560. For example, the collected RF environment data may be transmitted to the network controller over at least one of the wired interface and the wireless interface.

In the foregoing description, numerous details are set forth to provide an understanding of the present disclosure. However, it will be understood by those skilled in the art that the present disclosure may be practiced without these details. While the disclosure has been described with respect to a limited number of examples, those skilled in the art will appreciate numerous modifications and variations therefrom. It is intended that the appended claims cover such modifications and variations as fall within the true spirit and scope of the disclosure.

What is claimed is:

1. A device comprising:
a network interface comprising at least one of a wired interface and a wireless interface; and
a processor to:
receive a request for radio frequency (RF) environment data from a network controller through the network interface;
initiate an RF scan to collect the RF environment data, responsive to the request; and
initiate transmission of the RF environment data to the network controller through the network interface.

2. The device of claim 1, wherein the RF environment data is usable by the network controller to manage and optimize an RF network.

3. The device of claim 2, wherein the RF environment data comprises at least one of a list of wireless entities detectable by the device, operating channels of the wireless entities, signal strength data of the wireless entities, data related to packets transmitted over the RF network, identifying information related to the wireless entities, and a current location of the device.

4. The device of claim 3, wherein the list of wireless entities includes at least one of access points, ad-hoc cells, mobile devices, and Bluetooth devices.

5. The device of claim 3, wherein the signal strength data includes at least one of signal to noise ratio (SNR), signal to interference plus noise ratio (SINR), received signal strength indication (RSSI), modulation and coding scheme (MCS), and transmit power level.

6. The device of claim 3, wherein the packet data includes content and types of data sent/received over the RF network, and the wireless entities responsible for sending/receiving the packets.

7. The device of claim 3, wherein the identifying information related to the wireless entities includes at least one of service set identification (SSID), media access control (MAC) address, and internet protocol (IP) address, and wherein the wireless entities includes a particular wireless entity to which the device is associated.

8. The device of claim 1, wherein when the device is connected to the network controller via the wired interface, the processor to:
receive the request via the wired interface;
enable the wireless interface of the device to initiate the RF scan; and
initiate transmission of the RF environment data to the network controller via at least one of the wired interface and the wireless interface.

9. The device of claim 8,
wherein the wired interface comprises at least one of an Ethernet port, an external adaptor, and a wired connection to another device connected to a network, and
wherein the wireless interface comprises a wireless local area network (WLAN) interface.

10. The device of claim 1, wherein the device comprises at least one of a tablet, a smart phone, a cellular device, a personal digital assistant (PDA), an all-in-one (AIO) computing device, a notebook, a convertible or hybrid notebook, a netbook, a computing device, a printing device, and any other wireless capable device.

11. A method comprising:
receiving, by a device, a request for radio frequency (RF) environment data from a network controller, wherein the request is received over a network interface of the device, and wherein the network interface includes at least one of a wired interface and a wireless interface;
negotiating data collection and transfer parameters with the network controller;
initiating an RF scan to collect the RF environment data based on the data collection parameters;
transmitting the collected RF environment data to the network controller over the network interface based on the transfer parameters.

12. The method of claim 11,
wherein the data collection parameters include at least one of frequency bands and channels to scan, wireless entities to scan, and data collection frequency, and
wherein the data transfer parameters include at least one of data transfer rate, data transmission frequency, data transfer method, coding and encryption schemes, and any other data transfer protocols.

13. The method of claim 11, comprising:
initiating the RF scan during an idle period of communication over the wireless interface;
collecting and aggregating the RF environment data over a period of time;
time stamping the collected RF environment data; and
transmitting the collected RF environment data to the network controller.

14. A non-transitory computer-readable storage medium comprising instructions that, when executed by a processor of a network controller, cause the network controller to:
send a request for radio frequency (RF) environment data to a plurality of client devices over a network interface, wherein the network interface includes at least one of a wired interface and a wireless interface;
negotiate data collection and transfer parameters with the plurality of client devices;
receiving the RF environment data from the plurality of client devices over the network interface based on the data collection and transfer parameters.

15. The non-transitory computer-readable storage medium of claim 14, wherein the request is sent via at least one of a dynamic host configuration protocol (DHCP) option, a multicast message to the plurality of client devices, and information element included in a beacon transmitted by an access point (AP) associated with the plurality of client devices.
